(19) United States
(12) Patent Application Publication
(10) Pub. No.: US 2012/0228042 A1
(43) Pub. Date: Sep. 13, 2012

(54) MOTORIZED WHEELCHAIR

(75) Inventors: Peter JOST, Kalletal (DE); Ralf RITTER, Bad Oeynhausen (DE)

(73) Assignee: Invacare International Sàrl, Gland (CH)

(21) Appl. No.: 13/413,839

(22) Filed: Mar. 7, 2012

(30) Foreign Application Priority Data
Mar. 7, 2011 (EP) 11157165.9

(51) Int. Cl. B60K 1/00

(52) U.S. Cl. 180/65.51

(57) ABSTRACT

A motorized wheelchair includes a frame, a battery support assembly that supports a battery box and is connected to the frame, first and second power drive assemblies disposed on each lateral side of the wheelchair, first and second rear wheels driven by the power drive assemblies, first and second castor wheels driven by the power drive assemblies, and first and second castor wheels that are pivotally connected to said frame. The battery support assembly is pivotally connected to the frame by a first connecting arrangement, so that said battery support assembly can pivot around a first longitudinal axis. The battery support assembly is pivotally connected to the first connecting arrangement by a second connecting arrangement, so that the battery support assembly can pivot around a second lateral axis.

### RELATED APPLICATIONS

The present application claims the benefit of European Patent Application No. 11157165.9, filed on Mar. 7, 2011, which is incorporated herein by reference in its entirety.

### TECHNICAL FIELD

The present invention relates to a motorized wheelchair. More particularly, the present invention relates to a construction of the chassis of a motorized wheelchair, which is as compact as possible.

### Prior Art and the Problem Underlying the Invention

Power drive or motorized wheelchairs in general are known in the art to provide motorized mobility to persons confined to a wheelchair. Such power drive wheelchairs conventionally comprise a relatively sturdy wheelchair frame supported on wheels for rolling movement, in combination with one or more batteries for supplying electrical power to one or more electrical motors coupled to the drive wheels of the wheels. The wheelchair frame further carries a seat module including a seat and a backrest as well as armrests.

One of the problems associated with motorized wheelchairs is that they require large batteries to have a long drive range. These large batteries lead to enlarge the width of the wheelchair. Moreover, if one needs a faster motorized wheelchair, it is also imperative to use larger motors. Considering that the motors are generally positioned at the same level as the batteries in a conventional motorized wheelchair, it is often difficult to propose a motorized wheelchair possessing a high speed and a long drive range which has also a small width. The width of the wheelchair is important for the user, since it has a direct impact on how easy it is to drive through narrow doors.

In the state of art, EP 2 226 048 A1 reveals motorized wheelchairs in which the motors are fixed on swing arms located left and right of batteries, said swing arms being pivotally connected on the wheelchair frame. To avoid contact between the swing arms and the batteries during the wheelchair's motion, a space of about 1 to 1.5 cm between them is provided. This additional space is clearly an obstacle to reduce the lateral extension of the wheelchair.

Therefore, a first objective of the present invention is to provide a motorized wheelchair that is as compact as possible.

A second objective of the present invention is to provide a motorized wheelchair in which the rear wheel suspension is improved.

### SUMMARY OF INVENTION

In an aspect, the present invention provides a motorized wheelchair comprising :
a frame, defining a longitudinal direction and a lateral direction perpendicular to said longitudinal direction,
a battery support assembly for supporting at least one battery box, said battery support assembly being connected to said frame,
first and second power drive assemblies disposed on each lateral side of the wheelchair, each of the assemblies comprising a motor and a gearbox assembly,
first and second rear wheels respectively driven by said first and second power drive assemblies,
first and second castor wheels pivotally connected to said frame,
   wherein said first and second power drive assemblies are directly fixed on the battery support assembly,
   wherein said battery support assembly is pivotally connected to said frame by a first connecting arrangement, so that said battery support assembly can pivot around a first longitudinal axis, and wherein said battery support assembly is pivotally connected to said first connecting arrangement by a second connecting arrangement, so that said battery support assembly can pivot around a second lateral axis.

Further aspects and preferred embodiments are provided in the appended claims.

### BRIEF DESCRIPTION OF THE DRAWINGS

The wheelchair of the present invention will be described in further detail further below, when useful with reference to the attached drawings, which show an exemplary wheelchair according to the invention.

FIG. 1 is a front perspective view showing the base of a conventional motorized wheelchair, from which the seat construction, including armrests and legrests, and the battery boxes were removed.

FIG. 2 is a rear view of the same wheelchair base as shown in FIG. 1, in which the battery boxes are replaced inside the base.

FIG. 3 is an exploded front perspective view showing the base of a wheelchair according to an embodiment of the invention, from which the seat construction, including armrests and legrests, is removed.

FIG. 4 is a rear assembled view of the wheelchair base of FIG. 3.

### DETAILED DESCRIPTION OF THE PREFERRED EMBODIMENTS

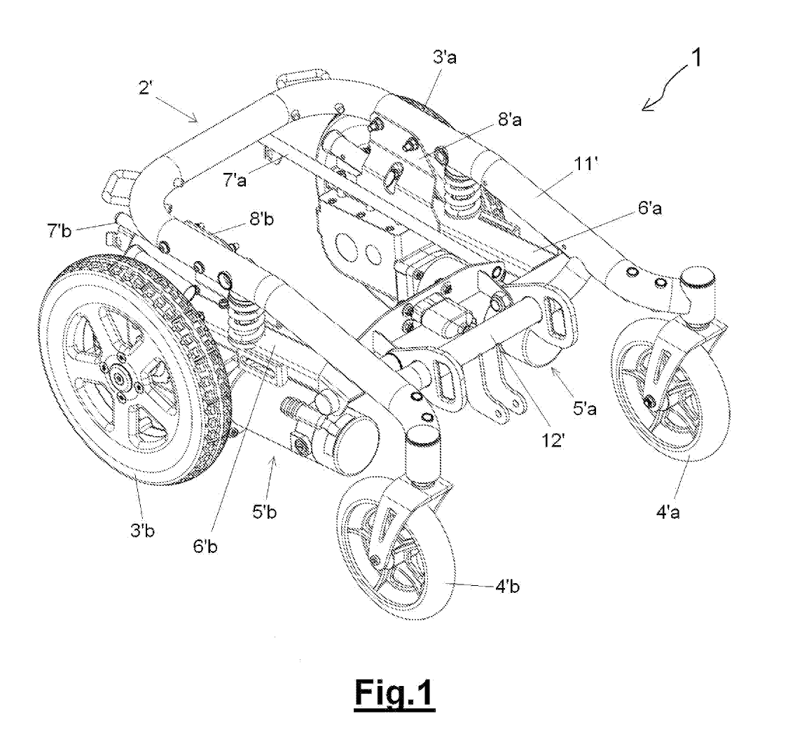

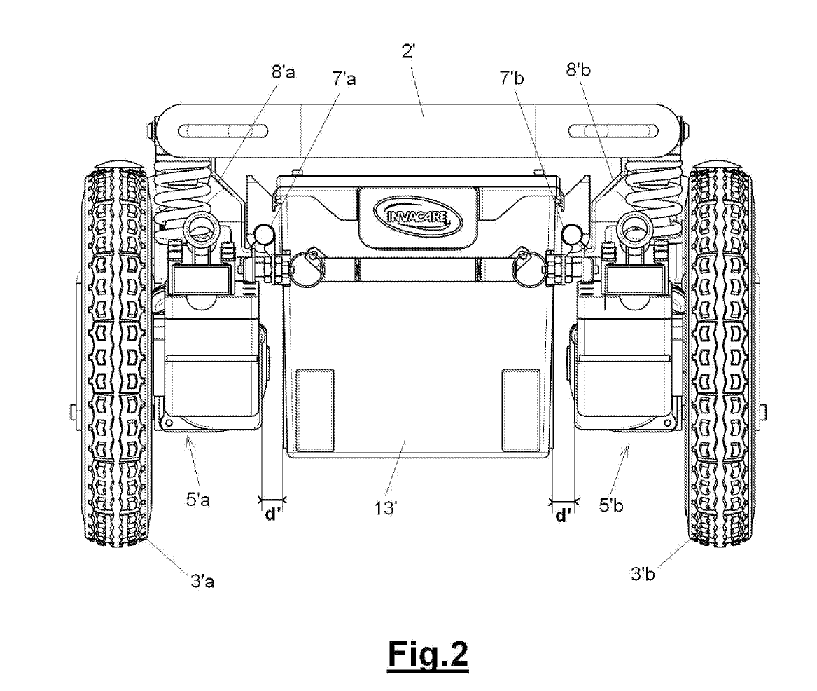

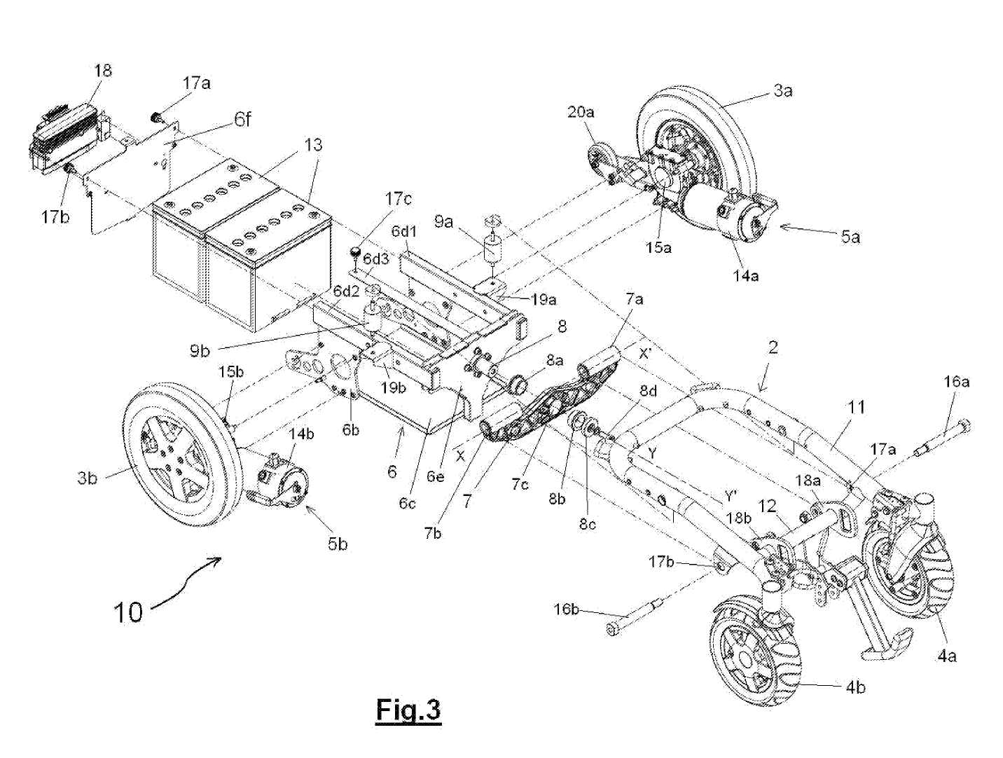

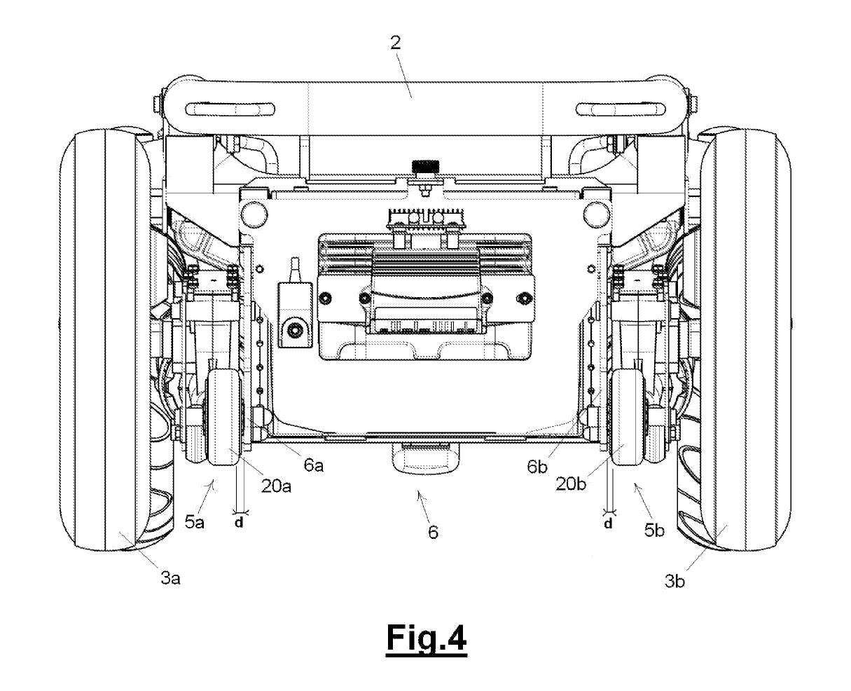

For the purpose of the present specification, situations and directions of elements of the wheelchair of the present invention are determined by the perspective of a user seated in the wheelchair. Accordingly, the left side of the wheelchair corresponds to the left side of FIGS. 2 and 4 or to the right side of FIGS. 1 and 3. The situations or directions “up” or “top” and “down” or “bottom”, “rear” or “back” and “front”, “behind” and “in front”, “distal” and “proximal”, “lateral” and “central” follow the same rule.

The present invention relates to a motorized wheelchair. The motorized wheelchair may be a dismountable wheelchair, meaning that at least a part of the wheelchair can be reversibly removed from the wheelchair. In this way, it is possible to remove at least one part, for example for the purpose of repairing the part or in order to arrange the wheelchair in a more space-saving manner, for example for storage and/or transport of the wheelchair.

FIGS. 1 and 2 show a base of a conventional motorized wheelchair 1 with the seat, armrests and legrests of the wheelchair being removed for the reasons of clarity. Any one selected from the seat, the armrests, the legrests and/or the battery boxes may be demountable and remountable. The wheelchair of FIGS. 1 and 2 comprises a frame 2′, said frame being formed by a main, U-shaped frame element 11′, the open end of the U being oriented towards the front. A horizontal frame element 12′ is provided in a front area of the frame 2′. Said wheelchair 1 comprises also a pair of left and right rear wheels 3′a, 3′b and a pair of left and right front castor wheels 4′a, 4′b. A pair of left and right power drive assemblies 5′a, 5′b, each assembly comprising a motor and a gear box assembly, are provided in order to propel the left and right rear wheels 3′a, 3′b, respectively. The castor wheels 4′a, 4′b are pivotally connected at the free ends of the U-shape element 11′. The rear wheels 3′a, 3′b are rotatably coupled to the gearbox assembly of the power drive assemblies 5′a, 5′b, respectively. The power drive assemblies 5′a, 5′b are supported by left and right swing arms 6′a, 6′b, respectively, said swing arms 6′a, 6′b being pivotally connected to the U-shape element 11′ at their front ends. As best shown on FIG. 2, the free lateral space separating said swing arms 6′a, 6′b and said power drive assemblies 5′a, 5′b is configured to lodge at least one battery box 13′. The battery box 13′ is supported by left and right longitudinal rails 7′a, 7′b, extending parallely along each lateral side of the battery box 13′ and fixed on the frame 2′ by left and right connection plates 8′a and 8′b. When the battery box 13′ is in its position of use, one can see on FIG. 2 that the left, respectively right, side of the battery box 13′ is separated from the gear box of the left, respectively right, power drive assembly 5′a, respectively 5′b, by a distance d′. This distance d′ is necessary to prevent that a contact between the battery box 13′ and the gear box occurs during the wheelchair's motion. The distance d′ is generally chosen so as to be comprised between 1 cm and 1.5 cm. Thus, in this conventional wheelchair 1, the width of the frame 2′ encompasses up to 3 cm of useless space. The aim of the invention is therefore to provide a new construction reducing this useless space.

FIG. 3 shows a base of a motorized wheelchair 10 according to the invention with the seat, armrests and legrests of the wheelchair being removed for the reasons of clarity. Any one selected from the seat, the armrests, the legrests and/or the battery boxes may be dismountable and remountable. The wheelchair 10 comprises a frame 2, said frame being formed by a main, U-shaped frame element 11, the open end of the U being oriented towards the front, each leg of the U defining the longitudinal direction of the wheelchair 10 and the bottom of the U defining the lateral direction of the wheelchair 10, said lateral direction being perpendicular to said longitudinal direction. A horizontal frame element 12 is provided in a front area of the frame 2. Said wheelchair 10 comprises also a pair of left and right rear wheels 3a, 3b and a pair of left and right front castor wheel 4a, 4b. A pair of left and right power drive assemblies 5a, 5b, each assembly comprising a motor 14a, 14b and a gear box assembly 15a, 15b, are provided in order to propel the left and right rear wheels 3a, 3b, respectively. Each power drive assembly 5a, 5b comprises also a forked structure at its rear extremity, said forked structure rotatably supporting an anti-tip wheel 20a, 20b. The castor wheels 4a, 4b are pivotally connected at the free ends of the U-shape element 11. The rear wheels 3a, 3b are rotatably coupled to the gearbox assemblies 15a, 15b of the left and right power drive assemblies 5a, 5b, respectively. The gear box assemblies 15a, 15b of the left and right power drive assemblies 5a, 5b are fixedly and directly connected to the lateral sides of a battery support assembly 6 by screws or other similar means of connection. Said battery support assembly 6 is configured to support at least one battery box 13. In the illustrated embodiment, said battery box 13 having an approximately parallelepipedical form, said battery support assembly 6 defines approximately a parallelepipedical housing, said housing being defined, at its lateral sides, by left and right connecting plates 6a, 6b, on which is connected the left and right power drive assemblies 5a, 5b, respectively, at its lower side, by a plate 6c, supporting the lower side of said battery box 13, at its upper side, by three parallel crossbars 6d1, 6d2, 6d3, respectively positioned at the left, right and central part of said housing, said crossbars 6d1 and 6d2 extending above said left and right connecting plates 6a, 6b, respectively, and, at its rear side, by a rear plate 6f, which is fixedly connected to said crossbars 6d1, 6d2, 6d3 by three screws 17a, 17b, 17c, respectively, said rear plate 6f supporting at its rear side a socket 18 which is electrically connected to the battery box 13. At its front end, the battery support assembly 6 comprises also a front connecting plate 6e, which is pivotally connected to a bracket 7, so that said battery support assembly 6 can pivot around a longitudinal axis YY′. In the illustrated embodiment, the axis YY′ is enclosed in a vertical plane of symmetry for the wheelchair 10. A wide variety of connecting arrangements can be implemented to allow the battery support assembly 6 to pivot around the axis YY′. The illustrated connection arrangement connecting said connecting plate 6e and said bracket 7 comprises a cylindrical element 8 fixedly connected to said connecting plate 6e and extending in the axial direction YY′ from the front side of said plate 6e, said cylindrical element 8 being disposed, at least partially, inside a cylindrical hole 7c formed in the center part of said bracket 7, the internal diameter of said hole 7c being higher than the external diameter of said cylindrical element 8. This configuration permits to lodge in said hole 7c, between said element 8 and said bracket 7, a first and second annular bushing 8a, 8b, introduced inside said hole 7c from the rear and front sides, respectively, said element 8, said bushings 8a, 8b and said bracket 7 being connected together by a screw 8d engaging a threaded hole of said element 8 and acting against an end washer 8c which is in contact with said bushing 8b. However, any connection arrangement that allows the battery support assembly 6 to pivot around the axis YY′ can be used. In an exemplary embodiment, the battery support assembly is also pivotable about axis XX′. This pivoting about axis XX′ can be achieved in a variety of different ways. In the illustrated embodiment, said bracket 7 is also configured to pivotally connect said battery support assembly 6 to the wheelchair frame 2, so that said battery support assembly 6 can pivot around a lateral axis XX′. However, any connection arrangement that allows the battery support arrangement to pivot about axis XX′ can be used. In the illustrated embodiment, said axis XX′ is approximately perpendicular to said axis YY′. Thus, said bracket 7 comprises at its left and right upper sides a left and right tubular connecting elements 7a, 7b, respectively, said elements 7a, 7b extending in the axial direction XX′ and being in contact at their lateral ends with a pair of connecting plates 17a, 18a and 17b, 18b, respectively, of the wheelchair frame 2. Said connecting plates 17a, 18a, 17b, 18b are each perforated with a hole aligned in the axial direction XX′ with the axial apertures of said elements 7a, 7b so that two left and right bolts 16a, 16b permit the pivoting connection between said bracket 7 and said wheelchair frame 2. Finally, the battery support assembly 6 is connected to the underside of each leg of the U-shape frame element 11 by at least two shock absorbers 9a, 9b so as to restrain the pivoting movement of said battery support assembly 6 around the first axis XX′ and/or the second axis YY′. In the illustrated embodiment, said shock absorbers 9a, 9b consist in rubber springs, the lower side of said rubber springs 9a, 9b being supported by the central part of two U-shape elements 19a, 19b fixedly connected to the crossbars 6d1 and 6d2, respectively. However, any type of shock absorber or spring may be used.

FIG. 4 is a rear assembled view of the wheelchair base of FIG. 3. One can see on FIG. 4 that the left, respectively right, connecting plate 6a, respectively 6b, of the battery support assembly 6 is separated from the gear box of the left, respectively right, power drive assembly 5a, respectively 5b, by a distance d. This distance d depends only on the connecting means used to connect said power assemblies 5a, 5b to said battery support assembly 6. Indeed, contrary to the conventional wheelchair of FIGS. 1 and 2, the distance d between said battery support assembly 6 and said power drive assemblies 5a, 5b does not vary during the wheelchair's motion, because these two elements are fixedly connected together. Therefore, the distance d is generally less than 0.5 cm, and preferably less than 0.1 cm.

1. A motorized wheelchair comprising:
a frame, defining a longitudinal direction and a lateral direction perpendicular to said longitudinal direction,
a battery support assembly for supporting at least one battery box, said battery support assembly being connected to said frame,
first and second power drive assemblies disposed on each lateral side of the wheelchair, each of the assemblies comprising a motor and a gearbox assembly,
first and second rear wheels respectively driven by said first and second power drive assemblies,
first and second castor wheels pivotally connected to said frame,
wherein said first and second power drive assemblies are directly fixed on the battery support assembly,
wherein said battery support assembly is pivotally connected to said frame by first connecting arrangement, so that said battery support assembly can pivot around a first longitudinal axis, and wherein said battery support assembly is pivotally connected to said first connecting arrangement by second connecting arrangement, so that said battery support assembly can pivot around a second lateral axis.

2. The wheelchair of the preceding claim 1, wherein the distance separating said first and/or second power drive assemblies and said battery support assembly in the lateral direction is less than 0.5 cm, preferably less than 0.1 cm, and more preferably approximately null.

3. The wheelchair of the preceding claim 1, wherein said second axis being approximately perpendicular to said first axis.

4. The wheelchair of the preceding claim 1, wherein said first connecting arrangement comprises a bracket provided at its left and right upper sides with a left and right tubular connecting elements, respectively, said tubular connecting elements extending along the first longitudinal axis and being in contact at their lateral ends with a pair of connecting plates, respectively, of the frame, said connecting plates being each perforated with a hole aligned in the axial direction with the axial apertures of said tubular connecting elements so that two left and right bolts permit the pivoting connection between said bracket and said frame.

5. The wheelchair of the preceding claim 1, wherein said first connecting arrangement comprises a bracket provided at its upper side with at least one cylindrical connecting element, said cylindrical connecting element extending along the first longitudinal axis and being pivotally connected to the frame, in particular by a ball bearing or a roller bearing, so as to permit the pivoting connection between said bracket and said frame.

6. The wheelchair of the preceding claim 4, wherein said second connecting arrangement comprises a cylindrical element fixedly connected to the battery support assembly and extending in the axial direction from the front side of said battery support assembly, said cylindrical element being disposed, at least partially, and rotatably movable inside a cylindrical hole formed in the center part of said bracket.

7. The wheelchair of the preceding claim 1, wherein said battery support assembly is connected to the underside of said frame by at least one shock absorber so as to restrain the pivoting movement of said battery support assembly around said first and/or said second axis.

8. The wheelchair of the preceding claim 7, wherein said battery support assembly is connected to the underside of said frame by at least two shock absorbers disposed at each lateral side of said frame.

9. The wheelchair of the preceding claim 7, wherein said shock absorbers consist in springs providing three degrees of freedom.

10. The wheelchair of the preceding claim 9, wherein said shock absorbers consist in rubber spring.

11. The wheelchair of the preceding claim 1, wherein the frame is formed by a main, U-shaped frame element, the open end of the U being oriented towards the front, each leg of the U defining the longitudinal direction of the wheelchair and the bottom of the U defining the lateral direction of the wheelchair.

12. The wheelchair of the preceding claim 4, wherein said battery support assembly defines approximately a parallelepipedical housing, said housing being defined, at its lateral sides, by left and right connecting plates, on which is connected the left and right power drive assemblies, respectively, at its lower side, by a plate, supporting the lower side of said battery box, at its upper side, by three parallel crossbars, respectively positioned at the left, right and central part of said housing, said left and right crossbars extending above said left and right connecting plates, respectively, at its rear side, by a rear plate, which is fixedly connected to said crossbars by three screws, respectively, and at its front side, by a front connecting plate, which is pivotally connected to the bracket.
